(19) United States
(12) Patent Application Publication
(10) Pub. No.: US 2024/0198881 A1
(43) Pub. Date: Jun. 20, 2024

(54) Energy Absorbing Rail

(71) Applicant: APPLE INC., Cupertino, CA (US)

(72) Inventors: Luke T. Ottaway, Brisbane, CA (US); Derrick T. Jue, Sunnyvale, CA (US); Arturo Llamazares Domper, San Jose, CA (US); Thuan D. Doan, Palo Alto, CA (US); Jesse T. Buehler, Portola Valley, CA (US); Mikael P. Sedlacek, Carmel Valley, CA (US); Albert J. Golko, Saratoga, CA (US)

(21) Appl. No.: 18/592,628

(22) Filed: Mar. 1, 2024

Related U.S. Application Data
(63) Continuation of application No. PCT/US2022/042841, filed on Sep. 8, 2022.
(60) Provisional application No. 63/300,707, filed on Jan. 19, 2022.
(60) Provisional application No. 63/246,582, filed on Sep. 21, 2021.

(51) Int. Cl. B60N 3/02

(52) U.S. Cl. CPC B60N 3/02

(57) ABSTRACT

A rail that includes an energy absorbing portion surrounded by an outer portion. A connector includes a first end configured to be coupled to a structure and a second end coupled to the rail.

### CROSS-REFERENCE TO RELATED APPLICATIONS

This application is a continuation of International Application No. PCT/US2022/042841, filed on Sep. 8, 2022, which claims the benefit of U.S. Provisional Application No. 63/246,582, filed on Sep. 21, 2021, and claims the benefit of U.S. Provisional Application No. 63/300,707, filed on Jan. 19, 2022. The content of the foregoing applications is incorporated herein by reference in their entirety for all purposes.

### FIELD The present disclosure relates generally to support devices within a structure.

### BACKGROUND

Structures may include devices to support individuals as they enter and exit the structures. Support devices may include, for example, handles located external to the structures or within the structures.

### SUMMARY

One aspect of the disclosure is a vehicle that includes a body and a rail. The rail includes an energy absorbing portion surrounded by an outer portion. A connector includes a first end coupled to the body and a second end coupled to the rail.

Another aspect of the disclosure is a vehicle including a vehicle body that defines a passenger compartment. A rail is coupled to the vehicle body and is located in the passenger compartment. The rail includes a rigid, thin-walled outer portion and an energy absorbing portion positioned adjacent to an interior surface of the thin-walled outer portion.

Another aspect of the disclosure is a vehicle comprising a body and a connector coupled to and extending from the body. A support is coupled to and extends from the connector. An extensible portion is positioned around the support and has a deployed position and an undeployed position. An outer portion is positioned around the extensible portion and is configured to enclose the extensible portion when the extensible portion is in the undeployed position.

### BRIEF DESCRIPTION OF THE DRAWINGS

FIG. 1 is an illustration of a passenger support device including a rail coupled to a body.

FIG. 2 is a cross-section illustration of the rail with an energy absorbing portion, both of FIG. 1, taken along line A-A of FIG. 1.

FIG. 3 is a cross-section illustration of the rail of FIG. 1 with a honeycomb configuration, taken along line A-A of FIG. 1.

FIG. 4 is a cross-section illustration of another rail with an energy absorbing portion.

FIG. 5 is a cross-section illustration of yet another rail with an additional energy absorbing portion.

FIG. 6 is a cross-section illustration of a rail that has an oval or elliptical cross-sectional shape.

FIG. 7 is a cross-section illustration of a rail that has a sandwich configuration.

FIGS. 8-9 are cross-section illustrations of a rail in an undeployed position and a deployed position, respectively.

FIGS. 10-11 are cross-section illustrations of another rail in an undeployed position and a deployed position, respectively.

FIG. 12 is an illustration of a passenger support device including a telescopic rail coupled to a body.

FIG. 13 is an illustration of a first example implementation of a rail in a passenger compartment of a vehicle.

FIG. 14 is an illustration of a second example implementation of a rail in a passenger compartment of a vehicle.

FIG. 15 is a block diagram that shows an example of a vehicle.

FIGS. 16-17 are illustrations of a retractable passenger support device in a retracted configuration and a deployed configuration, respectively.

### DETAILED DESCRIPTION

With the ongoing development of autonomous driving systems, seat positions of passengers within a vehicle may change. For example, passenger seating in an autonomous vehicle may be arranged such that all passengers enter and exit from the same door. As another example, the seating may be arranged such that the passengers are seated facing one another, not facing the back of the person sitting in front. Depending on the type of autonomous vehicle and the seat positions of passengers, passenger support devices may not provide the desired support as passengers enter and exit the vehicle. New passenger support devices are thus required to support passengers when entering and exiting a vehicle. Such support devices must also comply with vehicle regulations.

The disclosure herein relates to passenger support devices that provide support to passengers, such as when entering and exiting a vehicle, and are configured to absorb energy in response to inadvertent contact of a passenger's body with the passenger support device. Inadvertent contact of the passenger's body with the passenger support device can occur during vehicle events. As used herein, the term “vehicle event” refers to instances in which the vehicle undergoes a sudden change in acceleration, speed, and/or direction (typically during a crash or an evasive maneuver). The passenger support device can be coupled to a body of the vehicle and extend into a passenger compartment of the vehicle. Positioned as described, a passenger can grip the passenger support device when entering and exiting the vehicle. In addition, the passenger support device is configured to absorb energy if contacted during a vehicle event. To absorb such energy, the passenger support device can be designed with a specific geometry and/or can include energy absorbing materials. In addition, in some implementations, the structures described herein may be incorporated in components other than passenger support devices, such as in structural components or aesthetic components that are located in the passenger compartment of the vehicle and are not necessarily used to support passengers.

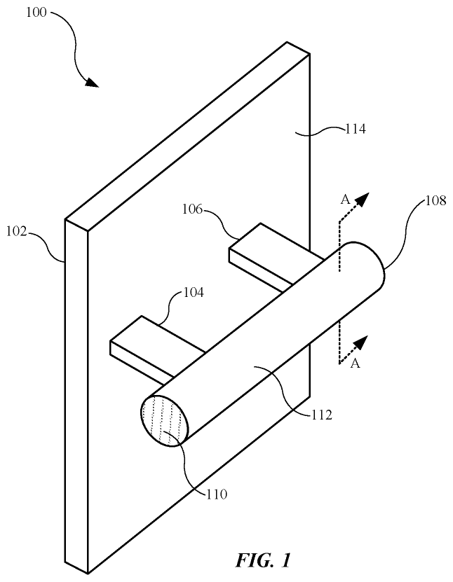

FIG. 1 is an illustration of a passenger support device 100 including a rail 108 coupled to a body 102. The body 102 can be a body of a vehicle that defines an interior surface 114 and an exterior surface (not shown). Extending from the interior surface 114 are a first connector 104 and a second connector 106 (referred to herein as “connectors 104, 106”). The connectors 104, 106 are rigid and couple the body 102 to the rail 108. In some implementations, the rail 108 is configured for use as a hand rail. In such implementations, the connectors 104, 106 are long enough to provide sufficient space for a hand of a passenger to fit between the rail 108 and the body 102 such that the passenger can grip the rail 108. Though two of the connectors 104, 106 are shown, one of skill in the art would understand that more or fewer of the connectors 104, 106 can be used.

The connectors 104, 106 can also be configured to absorb energy. For example, the connectors 104, 106 can be formed from an energy absorbing material such that a force imparted to the rail is at least partially absorbed by the connectors 104, 106. The connectors 104, 106 can also pivot and/or break upon being subjected to a threshold force. For example, the connectors 104, 106 can be weaker in one direction such that when a force is imparted to the rail 108, the connectors 104, 106 will yield and/or break in that direction in order to absorb energy from the force imparted to the rail 108.

The rail 108 is shown to include an outer portion 112 and an energy absorbing portion 110. The outer portion 112 is a thin-walled structure that is formed at least in part from a metal. As used herein, the term “thin-walled structure” refers to structures with a wall thickness of up to two millimeters. Though the outer portion 112 is shown to have a round cross-sectional shape, other cross-sectional shapes can be used. For example, the outer portion 112 can have a cross-sectional shape of a square, rectangle, racetrack, or any other suitable shape.

The energy absorbing portion 110 is positioned at least partially within the outer portion 112 such that the outer portion 112 at least partially surrounds the energy absorbing portion 110. In some implementations, the energy absorbing portion is positioned entirely within the outer portion 112 such that the outer portion 112 entirely surrounds the energy absorbing portion 110. The energy absorbing portion 110 abuts an interior surface of the outer portion 112 such that the interior surface of the outer portion 112 is in contact with the energy absorbing portion 110. Arranged as described, the energy absorbing portion 110 absorbs energy associated with a force imparted to the outer portion 112 from an impact. Such impact can occur during a vehicle event when an object contacts the outer portion 112. The energy absorbing portion 110 can absorb energy via the material from which the energy absorbing portion 110 is formed, the physical structure of the energy absorbing portion 110, or a combination thereof. Thus, the energy absorbing portion 110 reduces the amount of force imparted to an object or passenger that contacts the outer portion 112 during a vehicle event as compared to contact with a structure that does not have an energy absorbing portion.

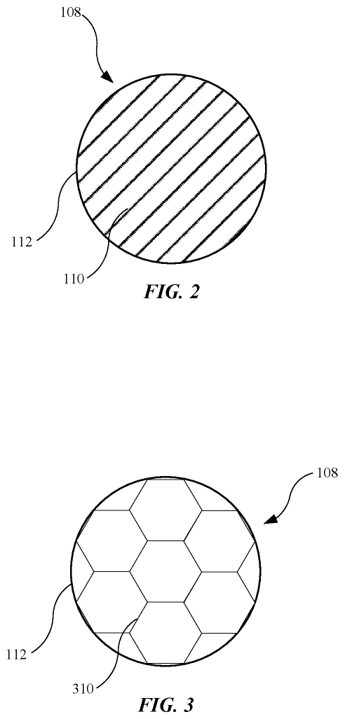

FIG. 2 is a cross-section illustration of the rail 108 with the energy absorbing portion 110, taken along line A-A of FIG. 1. The outer portion 112 is shown as having a circular cross-section that completely surrounds the energy absorbing portion 110. The outer portion 112 may have a diameter of between forty millimeters and sixty millimeters, inclusive. The energy absorbing portion 110 can be formed from a foam material and can include a rigid foam (e.g., a rigid polyurethane foam or an equivalent thereof), a compressible foam, an open cell foam, a closed cell foam, etc. The energy absorbing portion 110 absorbs and/or dissipates a force imparted to the outer portion 112 by deforming (either elastically or plastically), thereby absorbing the energy associated with the force. The energy absorbing portion 110 may also include deformable ribs that extend across opposing points positioned on an inner surface of the outer portion 112.

FIG. 3 is a cross-section illustration of the rail 108 with a honeycomb configuration 310. The honeycomb configuration 310 is positioned within the outer portion 112 and includes multiple struts coupled to each other to form the honeycomb pattern. The honeycomb configuration 310 can be formed from a metal, plastic, or composite material. The honeycomb configuration 310 can be affixed to an inner surface of the outer portion 112 such that the honeycomb configuration 310 is fixed relative to the outer portion 112. The honeycomb configuration 310 can also be movable relative to the outer portion 112. The honeycomb configuration 310 distributes a force imparted to the outer portion 112 between each of the struts such that the struts of the honeycomb configuration 310 deform and/or break, thereby absorbing the energy associated with the force.

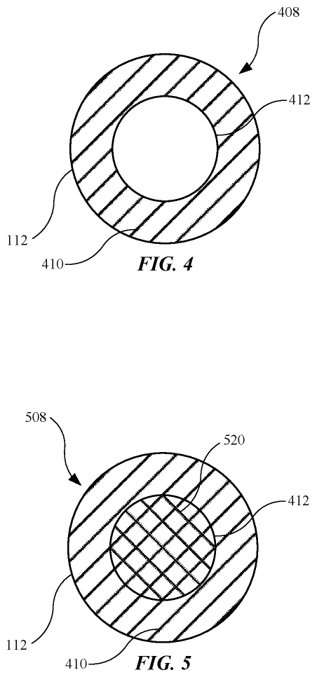

FIG. 4 is a cross-section illustration of a rail 408 with an energy absorbing portion 410. The rail 408 is similar to the rail 108 with the addition of an inner portion 412. The inner portion 412 can be a thin-walled structure similar to the outer portion 112. In some implementations, one or both of the outer portion 112 and the inner portion 412 have a tubular shape. The tubular shapes of the outer portion 112 and the inner portion 412 can be the same (for example, both the outer portion 112 and the inner portion 412 can be a cylindrical tube). The tubular shapes of the outer portion 112 and the inner portion 412 can also be different (for example, the outer portion 112 can be a cylindrical tube and the inner portion 412 can be a square tube). The material from which the inner portion 412 is constructed can be the same as the material of the outer portion 112. The material from which the inner portion 412 is constructed may also be a different material than the material of the outer portion 112. For example, the outer portion 112 may be formed from a metal and the inner portion may be formed from a plastic, and vice versa. An energy absorbing portion 410 is positioned between the outer portion 112 and the inner portion 412 and is similar to the energy absorbing portion 110.

FIG. 5 is a cross-section illustration of a rail 508. The rail 508 is like the rail 408 with an additional energy absorbing portion 520. The rail 508 may include the inner portion 412, located between the energy absorbing portion 410 and the additional energy absorbing portion 520, or the inner portion 412 may be omitted. The additional energy absorbing portion 520 can be formed from the same material as the energy absorbing portion 410. However, the additional energy absorbing portion 520 may also be formed from a different material than the energy absorbing portion 410. For example, the energy absorbing portion 410 may be formed from a rigid polyurethane foam and the additional energy absorbing portion 520 may be formed from a more compressible foam, and vice versa. As another example, the second energy absorbing portion 520 may be similar to the honeycomb structure 310 of FIG. 3 or may include deformable ribs extending across opposing points on an inner surface of the inner portion 412. In the illustrated implementation, the second additional absorbing structure 520 has a circular cross-sectional shape that is surrounded by the inner portion 412 and/or by the energy absorbing portion 410, but other geometric configurations may be used.

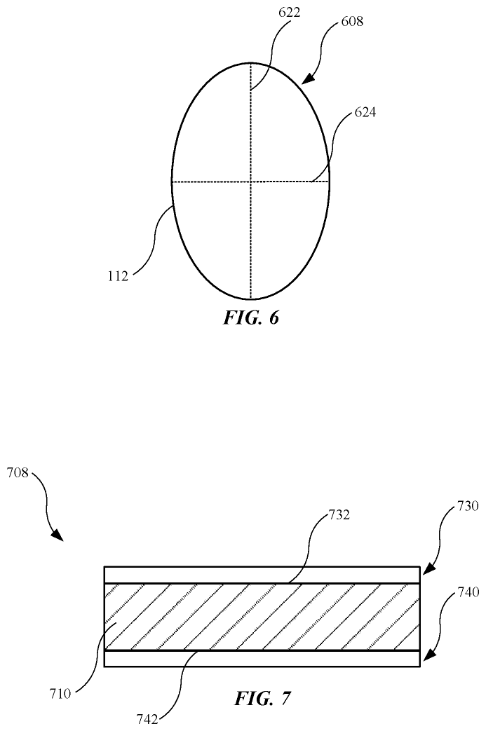

FIG. 6 is a cross-section illustration of a rail 608 that has an oval or elliptical cross-sectional shape. As shown, the rail 608 includes the outer portion 112 formed in the shape of an oval, which further includes a major axis 622 and a minor axis 624. The outer portion 112 is shown as defining an open space within the outer portion 112. The outer portion 112 can also surround an energy absorbing portion like those described above. The rail 608 can be more resistant to deformation along the major axis 622 than the minor axis 624 such that the rail 608 is more susceptible to deformation along the minor axis 624. Accordingly, the rail 608 can be oriented such that contact with the rail 608 (for example, during a vehicle event) occurs along the minor axis 624 such that the energy of the impact from the contact is absorbed by deformation of the rail 608 along the minor axis 624.

FIG. 7 is a cross-section illustration of a rail 708 that has a sandwich configuration. The rail 708 includes an outer portion 730, an inner portion 740, and an energy absorbing portion 710. The energy absorbing portion 710 abuts an inner surface 732 of the outer portion and an inner surface 742 of the inner portion 740 such that the energy absorbing portion 710 is secured between the outer portion 730 and the inner portion 740. The energy absorbing portion 710 can be similar to the energy absorbing portion 110. The materials from which the outer portion 730 and the inner portion 740 are formed can be the same (e.g., both can be formed from metal, plastic, etc.). The materials from which the outer portion 730 and the inner portion 740 are formed can also be different. For example, the outer portion 730 can be formed from a metal and the inner portion 740 can be formed from a plastic.

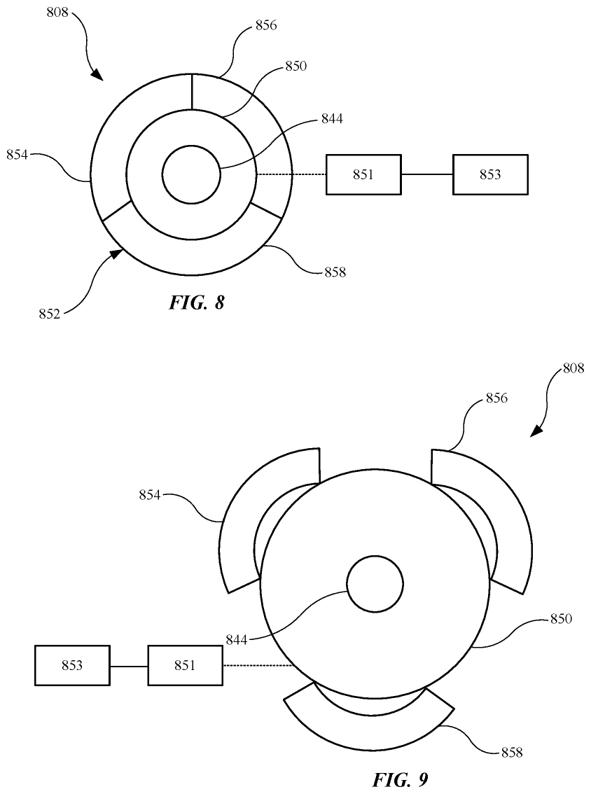

FIGS. 8-9 are cross-section illustrations of a rail 808 in an undeployed position and a deployed position, respectively. The rail 808 is shown to include a support 844, an extensible portion 850, and an outer portion 852. The support 844 can be a hollow or solid member (e.g., a rod, a bar, a shaft, etc.) extending at least partially along a length of the extensible portion 850. The extensible portion 850 is positioned on or around the support 844 such that the support 844 provides support for the extensible portion 850. The support can also include an energy absorbing portion like the energy absorbing portions described above. The extensible portion 850 is configured to expand from the undeployed position shown in FIG. 8 to the deployed position shown in FIG. 9. The extensible portion 850 can be an inflatable bladder similar to an airbag used in a vehicle. Accordingly, the extensible portion 850 can be filled with an inflation medium (e.g., air, foam, gel, etc.) to move the extensible portion 850 from the undeployed position to the deployed position. To facilitate moving the extensible portion 850 from the undeployed position to the deployed position, an inflator 851 is in fluid communication with the extensible portion 850. The inflator 851 can include a reservoir with the inflation medium and is configured to direct the inflation medium into the extensible portion 850. In some implementations, the inflator 851 may include a canister configured to hold the inflation medium at a high pressure. The inflator 851 can direct the inflation medium into the extensible portion 850 rapidly (e.g., by releasing the inflation medium from the canister) such that the extensible portion 850 moves from the undeployed position to the deployed position in less than, for example, approximately fifty milliseconds. As used herein, the term “approximately” when used in conjunction with a numerical value refers to numerical range within twenty percent of the stated value. For example, approximately fifty milliseconds refers to a range of values between forty milliseconds and sixty milliseconds. Inflating the extensible portion 850 within fifty milliseconds can ensure that, when a vehicle event occurs, an object or passenger that contacts the rail 808 will contact the rail 808 after the extensible portion 850 is in the deployed position. The inflator can also direct the inflation medium into the extensible portion 850 such that it takes longer than fifty milliseconds to move the extensible portion 850 from the undeployed position to the deployed position.

To allow the extensible portion 850 to expand without being restrained by the outer portion 852, the outer portion 852 may include two or more separable portions. In the illustrated implementation, the outer portion 852 includes a first portion 854, a second portion 856, and a third portion 858. The outer portion 852 can be formed from a thin-walled material similar to that of the outer portion 112. In the undeployed position, the first portion 854, the second portion 856, and the third portion 858 surround the extensible portion 850 such that the each of the first portion 854, the second portion 856, and the third portion 858 are in contact with the other two portions. Upon deployment of the extensible portion 850, the outer portion 852 is pushed outward (e.g., away from the support 844 in a radial direction) such that each of the first portion 854, the second portion 856, and the third portion 858 are separated from the other two portions and the extensible portion 850 is visible. Accordingly, the extensible portion 850 is configured to separate the separable portions when in the deployed position. As shown in FIGS. 8-9, the outer portion 852 includes three portions. However, one of skill in the art would understand that more or fewer portions can be used.

The rail 808 can transition from the undeployed position to the deployed position in a variety of ways. For example, the extensible portion 850 can be in communication with a controller 853 that monitors operation of the vehicle. Upon detection of a vehicle event, the controller 853 sends a signal to the inflator 851 to direct inflation medium into the extensible portion 850. In addition, operation of the extensible portion 850 can depend on an operative state of the vehicle. For example, when the vehicle is off (e.g., the engine is stopped) the extensible portion 850 is in the undeployed position, and upon starting the vehicle the controller 853 directs the inflator 851 to direct inflation medium into the extensible portion 850 such that the extensible portion 850 transitions to the deployed position. Accordingly, the extensible portion 850 can be cycled between the undeployed position and the deployed position.

Upon deployment of the extensible portion 850, the extensible portion 850 is configured to absorb energy associated with contact resulting from a vehicle event. For example, a vehicle event may include a sudden change in motion of the vehicle. The sudden change in motion causes controller 853 to direct the inflator 851 to inflate the extensible portion 850 with inflation medium. An object near the rail 808 can contact the outer portion 852 and/or the extensible portion 850 as a result of the vehicle event. In either case, the force of the object contacting the outer portion 852 and/or the extensible portion 850 is at least partially absorbed by the extensible portion 850.

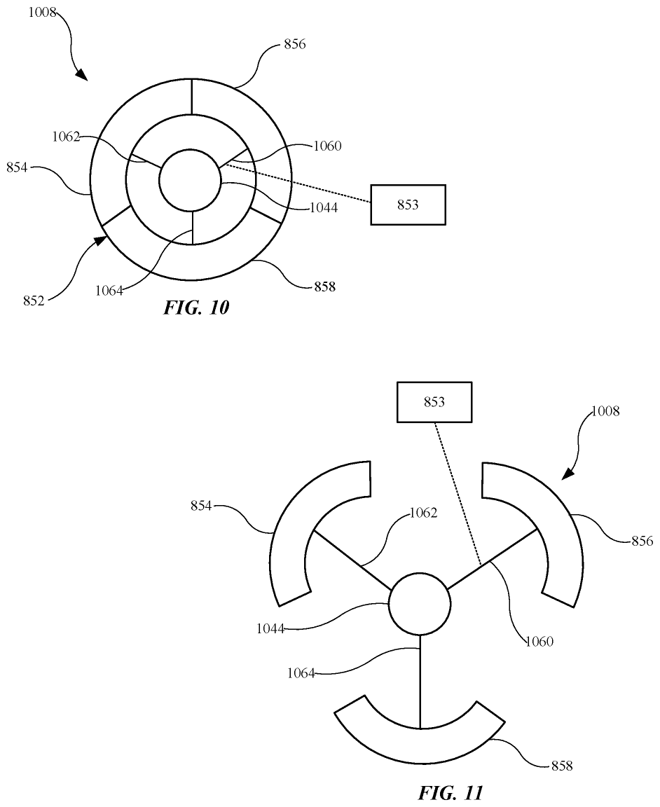

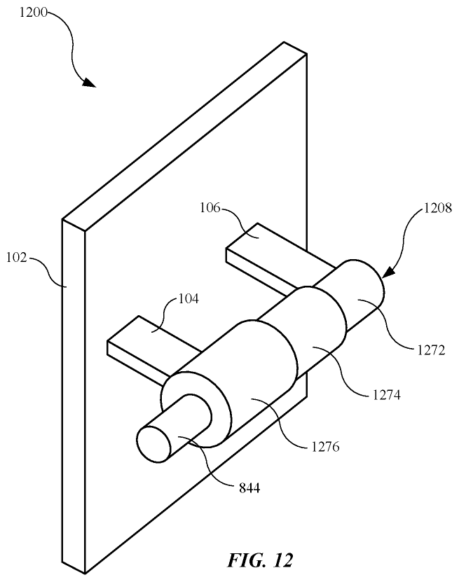

FIGS. 10-11 are cross-section illustrations of a rail 1008 in an undeployed position and a deployed position, respectively. The rail 1008 is shown to include a support rod 1044, a first extensible portion 1060, a second extensible portion 1062, and a third extensible portion 1064 (collectively referred to herein as “extensible portions 1060-1064”), and the outer portion 852. The support rod 1044 can be a hollow or solid member (e.g., a rod, a bar, a shaft, etc.) extending at least partially along a length of the rail 1008. The extensible portions 1060-1064 are positioned on or around the support rod 1044 such that the support rod 1044 provides support for the extensible portions 1060-1064. At least one of the extensible portions 1060-1064 couples the support rod 1044 to a respective portion of the outer portion 852. Accordingly, if additional extensible portions are implemented, the same number of additional portions of the outer portion 852 will also be implemented such that the ratio of extensible portions to portions of the outer portion 852 is one to one.

The extensible portions 1060-1064 are configured to extend from the undeployed position shown in FIG. 10 to the deployed position shown in FIG. 11. As shown, the extensible portions 1060-1064 are configured to extend radially outward from the support rod 1044 to reach the deployed position, and to retract radially inward toward the support rod 1044 to reach the undeployed position. Each of the extensible portions 1060-1064 includes a length that extends from an outer surface of the support rod 1044 to the respective portion of the outer portion 850, and the length of the extensible portions 1060-1064 may be longer than other characteristic dimensions of the extensible portions 1060-1064. For example, the length of the extensible portions 1060-1064 may be longer than a thickness, width, diameter, etc. of the extensible portions 1060-1064.

The extensible portions 1060-1064 can take a variety of forms that can be activated in different ways. For example, the extensible portions 1060-1064 can be an electromechanical device that includes threaded rods in communication with a motor, and the motor is in communication with a sensor and/or the controller 853. Upon detection of a vehicle event by the sensor and/or the controller 853, a signal is sent to the motor to rotate the threaded rods such that the extensible portions 1060-1064 are extended, thereby pushing each of the portions of the outer portion 852 away from each other and causing the rail 1008 to move to the deployed position. The extensible portions 1060-1064 can also include a pneumatic device that includes pistons coupled with one or more pressurized supplies in communication with a sensor and an actuator. Upon detection of a vehicle event by the sensor, a signal is sent to the actuator to release the pressurized supplies, causing the pistons to extend outward from the support rod 1044, thereby pushing each of the portions of the outer portion 852 away from each other and causing the rail 1008 to move to the deployed position.

Additionally, the extensible portions 1060-1064 can also include resilient portions (for example, a spring, a rubber material, etc.) that are held in tension by an actuator that is in communication with a sensor. Upon detection of a vehicle event by the sensor, a signal is sent to the actuator to release the tension, thereby causing the resilient portions to move outward from the support rod 1044, thereby pushing each of the portions of the outer portion 852 away from each other and causing the rail 1008 to move to the deployed position.

Upon deployment of the extensible portions 1060-1064, the extensible portions 1060-1064 are configured to absorb energy associated with a contact resulting from a vehicle event. For example, a vehicle event may include a sudden change in motion of the vehicle. The sudden change in motion causes the extensible portions 1060-1064 to deploy. An object near the rail 1008 can contact the outer portion 852 as a result of the vehicle event. The force of the object contacting the outer portion 852 is at least partially absorbed by the extensible portions 1060-1064.

Operation of the extensible portions 1060-1064 can depend on an operative state of the vehicle. For example, when the vehicle is off (e.g., the engine is stopped) the extensible portions 1060-1064 are in the undeployed position, and upon starting the vehicle the extensible portions 1060-1064 transition to the deployed position. Additionally, the extensible portions 1060-1064 can be activated only upon detection of a vehicle event, as described. Accordingly, the extensible portions 1060-1064 can be cycled between the undeployed position and the deployed position.

FIG. 12 is an illustration of a passenger support device 1200 including a telescopic rail 1208 coupled to the body 102 of FIG. 1. The passenger support device is also shown to include the support 844, and the telescopic rail 1208 further includes a first nested portion 1272, a second nested portion 1274, and a third nested portion 1276 (collectively referred to herein as “nested portions 1272-1276”). Each of the nested portions 1272-1276 can be similar to any one of the structures described with reference to FIGS. 1-6 such that the nested portions 1272-1276 can include one or more energy absorbing portions. The nested portions 1272-1276 are structured to fit at least partially within each other such that the passenger support device 1200 has an undeployed position and a deployed position. In the undeployed position, the nested portions 1272-1276 are positioned within each other such that the support 844 is exposed. In the deployed position, the nested portions 1272-1276 are extended such that the support 844 is covered.

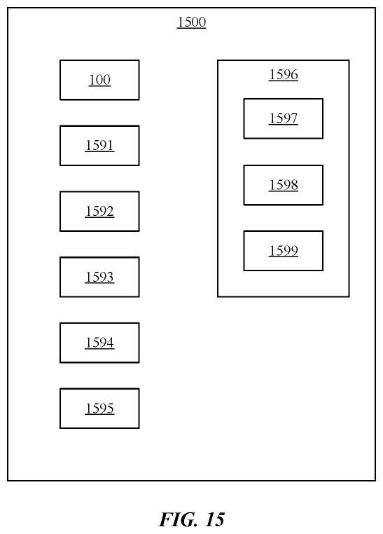

To transition from the undeployed position to the deployed position, the passenger support device 1200 can also include sensors 1592and a control system 1591, as described with reference to FIG. 15. The sensors 1591 notify the control system 1591 when a vehicle event occurs, and the control system 1591 sends a signal to an actuator to transition the nested portions 1272-1276 from the undeployed position to the deployed position. The actuator may be hydraulic, pneumatic, electro-mechanical, or a combination thereof. For example, the actuator may include a canister that holds a pressurized gas that, when a vehicle event is detected, is released and causes the nested portions 1272-1276 to move from the undeployed position to the deployed position.

The telescopic rail 1208 can transition from the undeployed position to the deployed position in a variety of ways. For example, the nested portions 1272-1276 can normally be in the undeployed position. Upon detection of a vehicle event, the controller sends a signal to the actuator to move the nested portions 1272-1276 to the deployed position. In addition, operation of the telescopic rail 1208 can depend on an operative state of the vehicle. For example, when the vehicle is off (e.g., the engine is stopped) the nested portions 1272-1276 are in the undeployed position, and upon starting the vehicle the nested portions 1272-1276 transition to the deployed position. Accordingly, the nested portions 1272-1276 can be cycled between the undeployed position and the deployed position upon starting and stopping the engine. Upon deployment of the nested portions 1272-1276, the nested portions 1272-1276 are configured to absorb energy associated with contact resulting from a vehicle event.

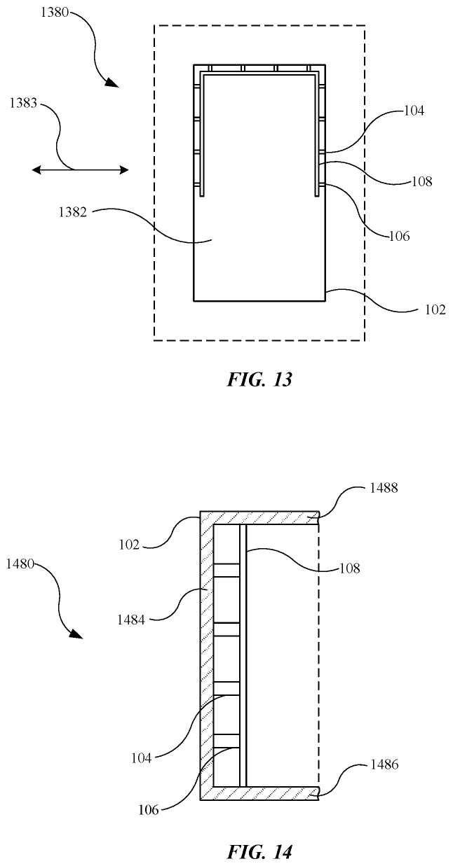

FIG. 13 is an illustration of a first example implementation of a rail in a passenger compartment 1380 of a vehicle. Though the rail 108 is shown in FIG. 13, any of the rails described above can be implemented. The passenger compartment 1380 is shown to include an opening 1382 (e.g., a door opening) defined by the body 102. Passengers can enter and exit the passenger compartment 1380 via the opening 1382. For example, passengers enter and/or exit the vehicle in a direction transverse to the direction of travel of the vehicle indicated by the arrow 1383. As shown, the rail 108 extends across a top of the opening 1382 and at least partially along each side of the opening 1382. In some instances, the rail 108 only extends across the top of the opening 1382. The rail 108 can also extend along just one or both sides of the opening 1382. The top of the opening 1382 is oriented approximately parallel with the direction of travel of the vehicle and is positioned opposite a floor of the vehicle, and each side of the opening 1382 is oriented approximately perpendicular to the direction of travel of the vehicle. Accordingly, the rail 108 can be used by passengers as an aid to grasp and hold when entering and exiting the passenger compartment 1380. The rail 108 acts as an energy absorber in the event of contact with the rail 108 resulting from a vehicle event.

FIG. 14 is an illustration of a second example implementation of a rail in a passenger compartment 1480 of a vehicle. Though the rail 108 is shown in FIG. 14, any of the rails described above can be implemented. The passenger compartment 1480 is shown to include a vehicle support 1484 (e.g., a structural pillar) defined by the body 102. The vehicle support 1484 supports an upper portion 1488 of the passenger compartment 1480 that is positioned above a lower portion 1486 of the passenger compartment 1480. As shown, the rail 108 is coupled to the vehicle support 1484 and extends from the upper portion 1488 to the lower portion 1486. The rail 108 can also partially extend between the upper portion 1488 and the lower portion 1486. Though a single vehicle support 1484 is shown, one of skill in the art would understand that two or more vehicle supports 1484 can be used in a vehicle. In instances where two or more vehicle supports 1484 are implemented in a vehicle, a rail 108 can be positioned on each of the vehicle supports 1484. The rail 108 can be used by passengers to grasp and hold when entering and exiting the passenger compartment 1380 and can act as an energy absorber in the event of contact with the rail 108 resulting from a vehicle event.

FIG. 15 is a block diagram that shows an example of a vehicle 1590 that includes a passenger support device, such as the passenger support device 100. The vehicle 1590 may be an automobile, such as a car, a truck, or a bus, of the type that is configured to travel on a road, and of the type that is configured to carry passengers and or/cargo. The vehicle 1590 may include a control system 1591 (e.g., including the controller 853) and sensors 1592 that control vehicle functions including control of some of the passenger support devices described herein. The vehicle 1590 may also include vehicle components, such as a vehicle body 1593 (e.g., including the body 102), a propulsion system 1594, a braking system 1595, and a steering system 1596. These are examples of vehicle systems that may be included in the vehicle 1590, and additional systems may be included.

An example implementation of a computing device that can be used to implement the control system 1591 includes a processor 1597, a memory 1598, and a storage device 1599. The control system 1591 may include a bus or a similar device to interconnect the components. The control system 1591 may include computer program instructions (e.g., stored on the storage device 1599) that are configured to cause the control system 1591 to perform the computer-implemented functions described herein with respect to the vehicle 1590 and various systems thereof. The processor 1597 is operable to execute computer program instructions and perform operations described by the computer program instructions. As an example, the processor 1597 may be a device such as a central processing unit. The memory 1598 may be a short-term information storage device such as a random-access memory module. The storage device 1599 may be a non-volatile information storage device such as a hard drive or a solid-state drive. In an alternative implementation, the control system 1591 may be implemented using a special purpose computing device, such as an application-specific integrated circuit or a field-programmable gate array, instead of a general purpose computing device. The computing device may also be an on-board vehicle computer, a special purpose vehicle computer that may communicate with the on-board vehicle computer, a remote computer, or a cloud computing system.

The control system 1591 coordinates operation systems of the vehicle 1590, including the passenger support device 100 (e.g., including various implementations of the rail 108 described above). The control system 1591 may receive sensor outputs (e.g., signals, data, etc.) from the sensors 1592 that provide information regarding environmental conditions outside of the vehicle 1590, conditions inside of the vehicle 1590, operating conditions of the vehicle 1590, and/or other information. The control system 1591 may also receive signals from and/or send information to other systems of the vehicle 1590.

The sensors 1592 may capture or receive information related to systems of the vehicle 1590, and/or to an environment. The environment may include the passenger cabin of the vehicle 1590 and an outside environment that is external to the vehicle 1590. Information captured or received by the sensors 1592 can relate to occupants within a vehicle, other vehicles, pedestrians and/or objects in the external environment, operating conditions of the vehicle 1590, operating conditions of other vehicles, trajectories of other vehicles, and/or other conditions within the vehicle 1590 or exterior to the vehicle 1590. The sensors 1592 may include, as examples, radar sensors, LIDAR sensors, still cameras, and video cameras.

The control system 1591 uses information from the sensors 1592 to detect an actual vehicle event or a predicted vehicle event. As one example, an actual vehicle event can be detected by sensors that are associated with the vehicle 1590, such as impact sensors or accelerometers. Detection of an actual vehicle event may be performed using the information that is output by the sensors according to known techniques. The sensor signals from the sensors 1592 may be interpreted by the control system 1591, such as by comparing the magnitude of a sensor output sensor to a threshold value, to determine whether an actual vehicle event has occurred. As an example, an actual vehicle event may be detected when a sensed acceleration value exceeds a threshold value. A predicted vehicle event can be detected using the sensors 1592 to determine the current positions and trajectories of static or dynamic objects, and determine whether that the vehicle 1590 will collide with one or more of the static or dynamic objects (e.g., an imminent vehicle event) at a time in the future (e.g., milliseconds in the future, seconds in the future, etc.). Detection of a predicted vehicle event may be performed according to known techniques.

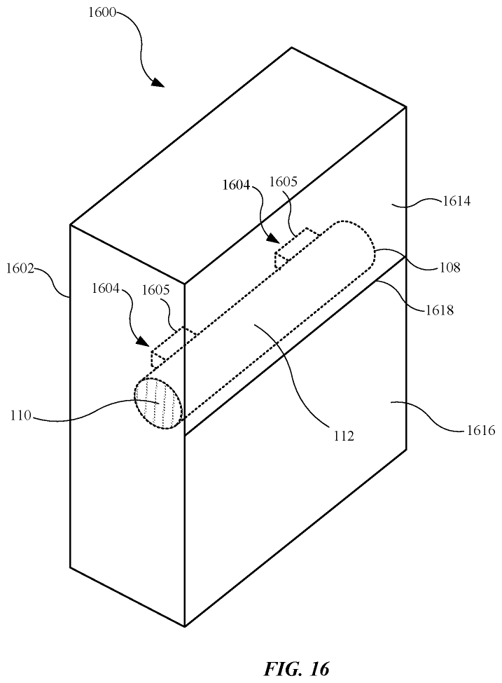

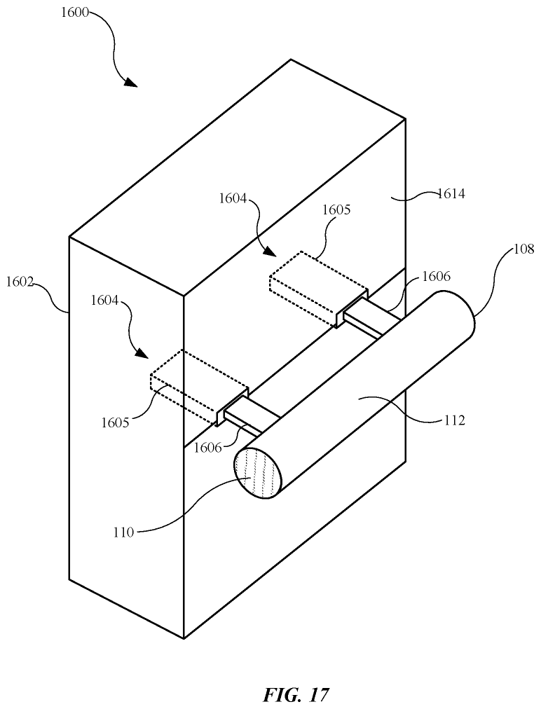

FIGS. 16-17 are illustrations of a retractable passenger support device 1600 in a retracted configuration and deployed configuration, respectively. The retractable passenger support device 1600 includes the rail 108 coupled to a body 1602 that defines an upper interior surface 1614 and a lower interior surface 1616. The body 1602 is similar to the body 102 and is configured to receive the retractable passenger support device 1600 within the body 1602. The upper interior surface 1614 and the lower interior surface 1616 are similar to the interior surface 114 and contact each other at a seam 1618. Positioned within and coupled to the body 1602 are retractable connectors 1604. The retractable connectors 1604 include a fixed end 1605 that is coupled to the body 1602. The retractable connectors 1604 also include a movable end 1606 that is coupled to the rail 108 and is movable relative to the fixed end 1605. In some embodiments, the movable end 1606 is configured to fit at least partially within the fixed end when the retractable passenger support device 1600 is in the retracted configuration such that the fixed end 1605 and the movable end 1606 have a telescoping relationship. For example, the movable end 1606 is configured to move between a first position in which the movable end 1606 is positioned within the body (e.g., within the fixed end 1605), and a second position in which the movable end 1606 protrudes beyond the body and into the passenger compartment. The retractable connectors 1604 may also be coupled with one or more actuators configured to move the movable end 1606 relative to the fixed end 1605.

In the retracted configuration, the rail 108 and the retractable connectors 1604 are positioned within the body 1602 and behind the upper interior surface 1614 and the lower interior surface 1616 (e.g., the rail 108 is enclosed by the body 1602). Positioned in this manner in the retracted configuration, neither the rail 108 nor the retractable connectors 1604 are visible to a vehicle occupant.

In the deployed configuration, the rail 108 is positioned outside of the body 1602 (e.g., protruding past the upper interior surface 1614 and the lower interior surface 1616 and within the passenger compartment of the vehicle). The movable end 1606 is positioned at least partially outside of the body 1602 and within the passenger compartment of the vehicle. The fixed end 1605 remains positioned within the body 1602. Accordingly, in the deployed configuration, both the rail 108 and a portion of the movable end 1606 are visible to a vehicle occupant.

The retractable connectors 1604 can be electronically coupled with the control system 1591 such that the control system 1591 controls the operation of the retractable connectors 1604 to deploy and retract the retractable passenger support device 1600 under certain conditions. For example, the retractable passenger support device 1600 may be configured to be in the deployed configuration when the vehicle is at rest (e.g., the engine is off, the vehicle is in “park,” the vehicle has zero speed, etc.) so that passengers may use the rail 108 for support during ingress and egress. In addition, the retractable passenger support device 1600 may be configured to be in the retracted configuration when the vehicle is moving (e.g., the vehicle has a nonzero speed and/or acceleration, the vehicle is in “drive,” etc.) to avoid a passenger striking the rail 108 during a vehicle event.

In an example embodiment, a driver may enter a vehicle that is turned off where the retractable connectors 1604 are in the deployed configuration. Passengers may also enter the vehicle and use the retractable connectors 1604 for support when entering the vehicle. When the driver changes the gear of the vehicle from “park” to “drive” or “reverse,” the control system 1591 may instruct the retractable connectors 1604 to retract, thereby causing the movable end 1606 to move toward the body 1602 and at least partially into the fixed end 1605. As a result, the rail 108 also moves toward the passenger compartment and enters the passenger compartment through the seam 1618. In some embodiments, the control system 1591 instructs the retractable connectors 1604 to retract upon receiving information from the sensors 1592 that the vehicle has a nonzero speed (e.g., the vehicle is moving).

The driver may then drive the vehicle to pick up another passenger and upon arriving to pick up the passenger, the driver stops the vehicle. In some instances, the driver may put the vehicle in “park,” but the driver may also hold down the brake pedal to prevent the vehicle from moving. In either case, the sensors 1592 provide information to the control system 1591 that the vehicle has zero speed, and the control system 1591 instructs the retractable connectors 1604 to deploy. The movable end 1606 then extends away from the fixed end 1605, pushing the rail 108 through the seam 1618, between the upper interior surface 1614 and the lower interior surface 1616, and into the interior of the vehicle so the rail 108 can be used for support.

What is claimed is:

1. A vehicle rail assembly, comprising:
a rail including an energy absorbing portion surrounded by an outer portion; and
a connector including a first end configured to be coupled to a body of a vehicle and a second end coupled to the rail.

2. The vehicle rail assembly of claim 1, further comprising an inner portion surrounded by the outer portion, wherein the energy absorbing portion is positioned between the inner portion and the outer portion.

3. The vehicle rail assembly of claim 2, further comprising ribs extending between opposing points positioned on an inner surface of the inner portion.

4. The vehicle rail assembly of claim 1, wherein the outer portion has a major axis and a minor axis, and the outer portion is more resistant to a force applied along the major axis than the minor axis.

5. The vehicle rail assembly of claim 1, wherein the energy absorbing portion includes a foam material.

6. The vehicle rail assembly of claim 1, wherein the energy absorbing portion includes a honeycomb configuration that has multiple struts coupled to each other and affixed to an inner surface of the outer portion.

7. The vehicle rail assembly of claim 1, wherein the energy absorbing portion includes ribs that extend across opposing points positioned on an inner surface of the outer portion.

8. The vehicle rail assembly of claim 1, wherein the connector includes a fixed end that is configured to be coupled to the body and a movable end that is coupled to the rail and is movable relative to the fixed end, wherein the fixed end and the movable end have a telescoping relationship.

9. The vehicle rail assembly of claim 8, wherein the fixed end is configured to be positioned within the body and the movable end is configured to move between a first position in which the movable end is positioned within the body, and a second position in which the movable end protrudes beyond the body and into a passenger compartment of the vehicle.

10. The vehicle rail assembly of claim 1, wherein the rail has an undeployed configuration in which the outer portion is configured to be enclosed within the body, and a deployed configuration in which the outer portion is configured to protrude beyond the body and into a passenger compartment vehicle.

11. The vehicle rail assembly of claim 1, wherein the energy absorbing portion includes an extensible portion that is coupled to and extends between a support rod and the outer portion, and is configured to extend radially outward from the support rod to reach a deployed position.

12. A vehicle, comprising:
a vehicle body that defines a passenger compartment;
a rail that is coupled to the vehicle body and is located in the passenger compartment, the rail including:
a rigid, thin-walled outer portion; and
an energy absorbing portion positioned adjacent to an interior surface of the thin-walled outer portion.

13. The vehicle of claim 12, wherein the rail has a retracted configuration in which the rail is positioned within the vehicle body and a deployed configuration in which the rail is positioned within a passenger compartment of the vehicle.

14. The vehicle of claim 13, wherein the vehicle body includes an upper interior surface that contacts a lower interior surface at a seam, and the rail is configured to extend through the seam to move from the retracted configuration to the deployed configuration to enter the passenger compartment.

15. The vehicle of claim 12, wherein the rail includes a sandwich configuration in which the energy absorbing portion abuts the interior surface of the thin-walled outer portion and an inner surface of an inner portion that is surrounded by the thin-walled outer portion.

16. The vehicle of claim 12, wherein the thin-walled outer portion includes separable portions, and the energy absorbing portion includes an extensible portion configured to expand from an undeployed position to a deployed position, wherein the extensible portion is configured to separate the separable portions when in the deployed position.

17. A vehicle, comprising:
a body;
a connector coupled to and extending from the body;
a support coupled to and extending from the connector;
an extensible portion positioned around the support, the extensible portion having a deployed position and an undeployed position; and
an outer portion positioned around the extensible portion and configured to enclose the extensible portion when the extensible portion is in the undeployed position.

18. The vehicle of claim 17, wherein the extensible portion includes an inflatable bladder configured to expand outward from the support.

19. The vehicle of claim 17, wherein the outer portion includes at least a first portion and a second portion, and the first portion and the second portion are in contact with each other when the extensible portion is in the undeployed position.

20. The vehicle of claim 19, wherein the first portion and the second portion separate when the extensible portion is in the deployed position.
